(19) United States
(12) Patent Application Publication
(10) Pub. No.: US 2010/0057865 A1
(43) Pub. Date: Mar. 4, 2010

(54) Transferable Debug Session in a Team Environment

(75) Inventors: Samantha Chan, Toronto (CA); Peter Andrew Nicholls, Janetville (CA)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/204,378

(22) Filed: Sep. 4, 2008

(51) Int. Cl. G06F 15/16

(52) U.S. Cl. 709/206; 709/227

(57) ABSTRACT

Methods, systems and computer program products for transferring debug sessions in a team environment. Exemplary embodiments include a method for transferring a debug session, the method including receiving a message that a first machine is to transfer the debug session, establishing a connection with a target machine to receive the debug session, receiving a message from the target machine that the debug session is accepted, terminating a connection with the first machine and sending debug session connection information to the target machine.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

1. Field

This invention relates to software development, and particularly to methods, systems and computer program products for transferring debug sessions in a team environment.

2. Background

Many software projects involve teams of individuals working on components that make up a larger system. During the development of these components and systems, problems can occur in the code, which can require debugging by one or more experts. Often the root cause of a problem is not known and a debugger is used to step through the code. Analysis is preformed to determine the cause of the error, which can be problematic in large teams and complex projects since it is not always known where the problem exists, and no one team member is an expert on the entire system. As such, the code can be debugged by individuals who may determine that their code is not at fault, and thus the problem is passed to someone else who begins the entire process and debug session all over again. In cases where it is difficult or time consuming to reproduce the problem this process is inefficient because the debug session begins each time the code is passed.

Current solutions to managing debug sessions among team members include screen sharing technologies allowing two people to see the same debug information, which can unnecessarily utilize resources on the original machine. Further solutions include save and replay techniques, which terminate the original session and establish an environment and session to replay saved scripts to a transfer point. Current solutions are unsatisfactory because many applications have high levels of complexity, which may result in an inability to reproduce the problem.

### BRIEF SUMMARY

Exemplary embodiments include a method for transferring a debug session, the method including launching the debug session, logging onto a debug server, sending a message to establish a connection between the debug server and a target machine, establishing the debug session with the debug server and transferring the debug session to the target machine.

Additional exemplary embodiments include a method for transferring a debug session, the method including receiving a message that a first machine is to transfer the debug session, establishing a connection with a target machine to receive the debug session, receiving a message from the target machine that the debug session is accepted, terminating a connection with the first machine and sending debug session connection information to the target machine.

Further exemplary embodiments include computer program product for transferring a debug session, the computer program product including instructions for causing a computer to implement a method, the method including receiving a message that a first machine is to transfer the debug session, establishing a connection with a target machine to receive the debug session, receiving a message from the target machine that the debug session is accepted, terminating a connection with the first machine and sending debug session connection information to the target machine.

Additional exemplary embodiments include a system for transferring a debug session from a first machine to a target machine, the system including a debug server configured for receiving a message that the first machine is to transfer the debug session, sending a message to the first machine to select a target machine to receive the debug session, receiving a message from the first machine to transfer the debug session to the target machine, locating information related to a target debug daemon, establishing a connection with the target debug daemon, receiving a message from the target machine that the debug session is accepted, terminating a connection with the first machine, sending debug session connection information to the target machine and disconnecting the connection with the target debug daemon.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### TECHNICAL EFFECTS

As a result of the summarized invention, technically we have achieved a solution which provides the ability to transfer live debug sessions in which a second person in the software team does not have to reestablish the debug environment and session state. The solution further reduces the number of debug environments that need to be duplicated and allows sessions to be transferred but not immediately connected to the second user, which allows problems (i.e., debug sessions) to be queued to the correct expert. The debug session can also be parked (held by the debug server) until someone is assigned the session enabling situations where the correct second user is not known until a later point. This also enables users to temporarily stop debugging a problem and resume the debug session at a later point. The solutions further provides unlimited transfers, which allows several people to look at the problem without having to restart. In addition, drag and drop of debug sessions provides fast method of communication to team members. Instant messages can describe the problem and include the link to access the session. Debug sessions can be left connected, but unassigned, thereby allowing dynamic work assignments. In the team environment, associated work artifacts such as defects, breakpoints, system input/output, debug session properties, notes, can also be transferred with the debug session. The solution can be used in conjunction with screen sharing solutions to allow an initial collaboration and then a transfer of the debug session.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary embodiment of a system for transferring debug sessions in a team environment;

FIG. 2 illustrates a block diagram of one example of the establishment of a debug session in a team environment in accordance with exemplary embodiments. In exemplary embodiments, the debug session includes several components;

FIG. 3 illustrates a block diagram of one example of a debug session after the setup/launch of the session as illustrated in FIG. 2 in accordance with exemplary embodiments; and

FIG. 4 illustrates a block diagram 4 of one example of the transfer of a debug session from one user to another user in a team environment in accordance with exemplary embodiments.

The detailed description explains the preferred embodiments of the invention, together with advantages and features, by way of example with reference to the drawings.

### DETAILED DESCRIPTION

Exemplary embodiments include methods, systems and computer program products that transfer an in-progress debug session from one person to another, which allows a user to debug to a certain point in the execution of the session and transfer the session to an expert in that area. The expert can, in turn, continue debugging the session and transfer the session to another expert until the problem is solved. This ability to transfer the session avoids the need to configure multiple test machines, enables experts to take over without having to go through all the preliminary steps to get to the section of code in question, and allows the session to be transferred multiple times.

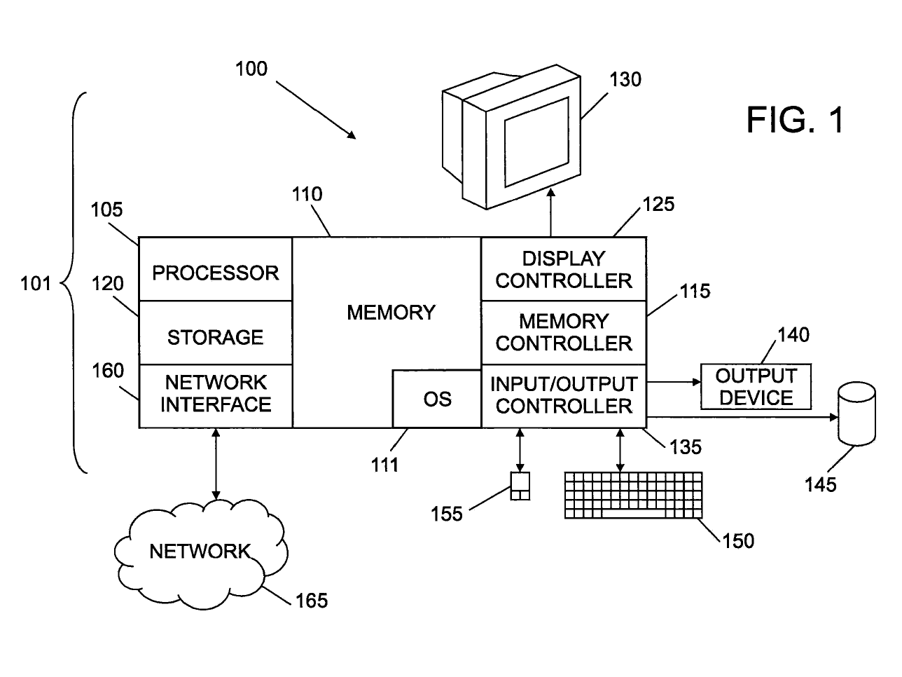

FIG. 1 illustrates an exemplary embodiment of a system 100 for transferring debug sessions in a team environment. The methods described herein can be implemented in software (e.g., firmware), hardware, or a combination thereof In exemplary embodiments, the methods described herein are implemented in software, as an executable program, and is executed by a special or general-purpose digital computer, such as a personal computer, workstation, minicomputer, or mainframe computer. The system 100 therefore includes general-purpose computer 101.

In exemplary embodiments, in terms of hardware architecture, as shown in FIG. 1, the computer 101 includes a processor 105, memory 110 coupled to a memory controller 115, and one or more input and/or output (I/O) devices 140, 145 (or peripherals) that are communicatively coupled via a local input/output controller 135. The input/output controller 135 can be, for example but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing software instructions.

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The software in memory 110 may include one or more separate programs, each of which comprises an ordered listing of executable instructions for implementing logical functions. In the example of FIG. 1, the software in the memory 110 includes the debug session transfer methods described herein in accordance with exemplary embodiments and a suitable operating system (OS) 111. The operating system 111 essentially controls the execution of other computer programs, such the debug session transfer systems and methods described herein, and provides scheduling, input-output control, file and data management, memory management, and communication control and related services.

The debug session transfer methods described herein may be in the form of a source program, executable program (object code), script, or any other entity comprising a set of instructions to be performed. When a source program, then the program needs to be translated via a compiler, assembler, interpreter, or the like, which may or may not be included within the memory 110, so as to operate properly in connection with the OS 111. Furthermore, the debug session transfer methods can be written as an object oriented programming language, which has classes of data and methods, or a procedure programming language, which has routines, subroutines, and/or functions.

In exemplary embodiments, a conventional keyboard 150 and mouse 155 can be coupled to the input/output controller 135. Other output devices such as the I/O devices 140, 145 may include input devices, for example but not limited to a printer, a scanner, microphone, and the like. Finally, the I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 100 can further include a display controller 125 coupled to a display 130. In exemplary embodiments, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In exemplary embodiments, network 165 can be a managed IP network administered by a service provider. The network 165 may be implemented in a wireless fashion, e.g., using wireless protocols and technologies, such as WiFi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the software in the memory 110 may further include a basic input output system (BIOS) (omitted for simplicity). The BIOS is a set of essential software routines that initialize and test hardware at startup, start the OS 111, and support the transfer of data among the hardware devices. The BIOS is stored in ROM so that the BIOS can be executed when the computer 101 is activated.

When the computer 101 is in operation, the processor 105 is configured to execute software stored within the memory 110, to communicate data to and from the memory 110, and to generally control operations of the computer 101 pursuant to the software. The debug session transfer methods described herein and the OS 111, in whole or in part, but typically the latter, are read by the processor 105, perhaps buffered within the processor 105, and then executed.

When the systems and methods described herein are implemented in software, as is shown in FIG. 1, it the methods can be stored on any computer readable medium, such as storage 120, for use by or in connection with any computer related system or method. In the context of this document, a computer readable medium is an electronic, magnetic, optical, or other physical device or means that can contain or store a computer program for use by or in connection with a computer related system or method. The debug session transfer methods described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In exemplary embodiments, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In exemplary embodiments, where the debug session transfer methods are implemented in hardware, the debug session transfer methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

In exemplary embodiments, the methods, systems and computer program products described herein create a debug session manager, which establishes the debug connections to the systems being debugged. A user can register to debug via the debug session manager and the debugging session occurs via the session manager. When a user wants to transfer a live debug session, the session manager exposes the team members to the user for selection. The session manager then disconnects the first user and transfers the debug session to the second user. The second user then updates their debug user interface to reflect the state in which the session is currently established. The second user can then proceed to debug from the point the first user transferred the session. The methods, systems and computer program products described herein also include the ability to transfer sessions to users not currently registered with the debug server (i.e., the session is suspended until the new user accepts the connection). The methods, systems and computer program products described herein also include the ability to drag and drop debug session to instant messaging clients for transfer and the ability to transfer associated work artifacts.

In exemplary embodiments, the methods, systems and computer program products described herein implement three phases in the transferable debug session. The first phase is a setup and launch of a debug session, the second phase is the debugging session, and the third phase is the transfer of the debug session and any related artifacts.

For illustrative purposes, the description of the transferable debug session methods, systems and computer program products includes Java debugging, but it is understood that the concepts apply to any connection-based debugger. To accomplish the three phases of the transferable debug session described above, a debug server component (i.e., Team Debug Server) acts as an intermediary between the debug client (user interface) and the debug engine (Target JVM). The server component can be a server itself or it can be a service component in an existing server. In exemplary embodiments, the debug server component provides several abilities, including, but not limited to: transferring a live debug session from user to another; recording each transfer and listing users who worked on session; maintaining comments about debug session that can be transferred; transferring sessions to a team that leaves session in a suspended state until a team member actively assumes the session; transferring the session to target users queue; managing the queues of debug sessions for target users; and automatically determining a target user based on knowledge from the team environment (i.e., areas of expertise)

In exemplary embodiments, for the setup and the launch, each user needs to login to the debug server component and register them for team debugging. The registration includes the capturing of the user's host information (e.g. IP address) and the debug daemon port that each user has open for inbound debug connections. In exemplary embodiments, the capturing of the user's host information (e.g. IP address) and debug daemon port can include a direct register for debug action, registration as part of logging into a team development server, and silent registration during startup. In exemplary embodiments, the debug server component can hold a list of user that are registered for debug and the means to connect to them (i.e., user's host information like the IP address and the port of the debug daemon).

In exemplary embodiments, the launch of the debug session can occur in a variety of ways. Regardless of the way that the debug session is launched, the debug server component holds the connection to the debug engine and the user (i.e., debug client) connects to the debug server component session.

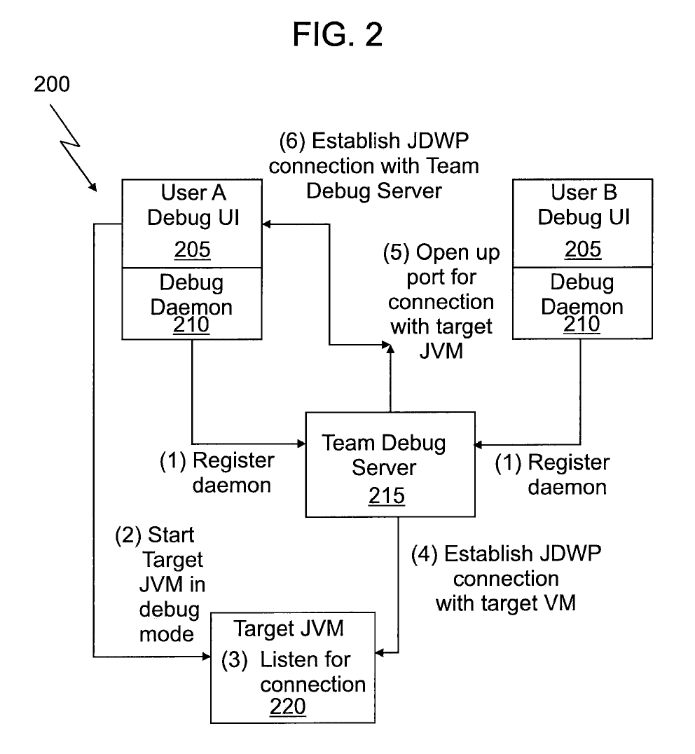

FIG. 2 illustrates a block diagram 200 of one example of the establishment of a debug session in a team environment in accordance with exemplary embodiments. In exemplary embodiments, the debug session includes several components. The debug session can include a debug user interface (UI) 205, which is the client that allows the user to control their debug session. As illustrated, a User A and a User B can each have their own debug UI 205. The debug UI can further include a debug daemon 210. In exemplary embodiments, each debug UI 205 owns a respective debug daemon 210. The debug daemon 210 opens up a socket, allowing a team debug server 215 to launch a debug session with the debug UI 205. In exemplary embodiments, the team debug server 215 manages the debug session with target virtual machines, in this case Java virtual machines (JVM) 220. The team debug server 215 is also responsible for the transfer of the debug session, as further described herein. In exemplary embodiments, the debug session further includes the target JVM 220, which is the JVM to be debugged. In exemplary embodiments the JVM 220 is a set of computer software programs and data structures, which use a virtual machine model for the execution of other computer programs and scripts.

In exemplary embodiments, during the setup/launch of the debug session 200, when the user launches the debug UI 205, the debug UI 205 launches the debug daemon 210. In turn, the debug daemon 210 opens up a port that listens for incoming debug sessions. The user can then log on to the team debug server 215. The debug daemon's 210 host and port information is registered with the team debug server 215 during login. The team debug server 215 maintains a list of users and their associated host and debug daemon 210 information. In exemplary embodiments, when the user starts a Java debug session, the target JVM 220 is started in a debug server mode. In the debug server mode, the target JVM 220 listens for debug connections on a specified port. The debug UI 205, in turn, tells the team debug server 215 to establish a communication protocol (e.g., a Java debug wire protocol (JDWP) debug connection) with the target JVM 220. The debug UI 205 then starts a Java debug session by establishing a JDWP debug connection with the team debug server 215. All JDWP conversations between the debug UI 205 and the target JVM 220 goes through the team debug server 215.

In exemplary embodiments, once the debug session is established the user can commence debugging. The team debug server 215 relays requests from the debug UI to the debug engine. The team debug server also relays any responses from the debug engine back to the debug UI. The team debug server 215 can be used to log this conversation, gather stats and perform other tasks related to the debug session.

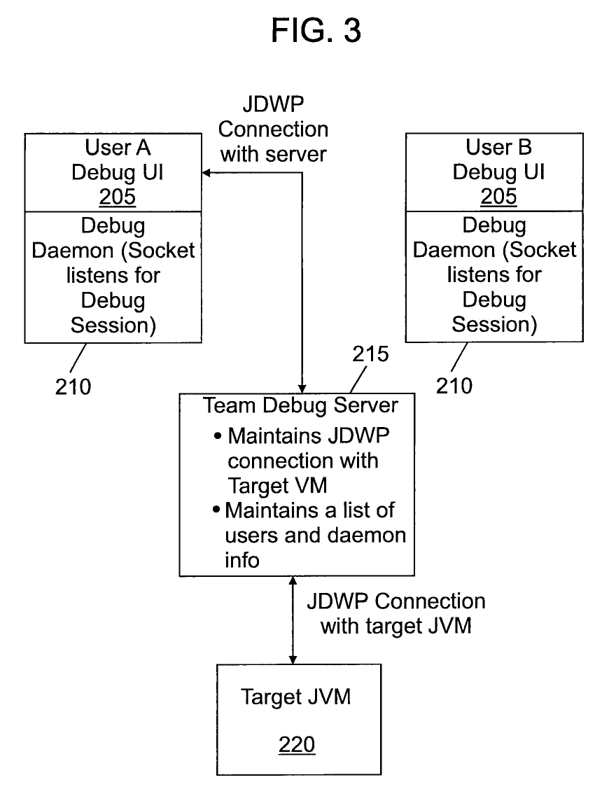

FIG. 3 illustrates a block diagram 300 of one example of a debug session after the setup/launch of the session as illustrated in FIG. 2 in accordance with exemplary embodiments. During the debug session, the user (e.g., User A) may decide to transfer the session to another user (e.g., User B). In exemplary embodiments, the transfer of the debug session is accomplished as now described. The user first identifies a target for the transfer. The debug UI then asks the team debug server to notify the target user of an incoming debug session. The team debug server looks up the host and daemon information of the target user from its user registry. The team debug server then establishes a connection with target user's debug daemon. Through communicating with the debug daemon, the debug server can prompt the target user if the incoming debug session should be accepted. If the target user agrees to accept the debug session, the debug UI sends a message back to the debug server. At this time, the system then disconnects User A by terminating the connection to User A. The system then connects to the target user (e.g., User B) by pushing a new inbound debug connection to his listening debug daemon 210, which in this case is the debug daemon associated with User B. Once in the process of connecting to User B, the system updated the target user client with a current state of the debug session. Finally, the system can optionally transfer any work-related artifacts associated with the debug session.

In exemplary embodiments, the methods, systems and computer program products described herein also provide the ability to queue debug sessions to users. For example, a target user may be busy at the moment of the transfer of the debug session. As such, the debug server 215 can disconnect User A and hold the session as queued for the target user. The target user can either be prompted or can simply look at the list of debug sessions from the debug server 215 that are queued for the target user, and select the session to connect and continue debugging. Sessions may also be transferred to a team (i.e., not a specific person) and a team member may select a session from the queue.

It is appreciated that a user of a debug session may be unsure to whom the user should transfer the debug session. In exemplary embodiments, the debug server 215 can provide a list of areas of expertise of several potential target users, thereby enabling the user to select an area that requires investigation for the debug session, and further enables the debug server 215 to transfer the debug session to the appropriate user. This selection and transfer can be performed either through registered areas of expertise, use of knowledge from the team environment on source code ownership and other appropriate factors related to the debug session.

In exemplary embodiments, the team debug server 215 may also maintain a list of related information about the debug session that can be transferred to the target user. It is appreciated that the information is not limited to debug specific artifacts (e.g., breakpoints, variable monitors) but can also be any known artifact (e.g., work item, use cases, notes, comments, URLs). The team debug server 215 may also automatically update artifacts to reflect the transfer. An example of this could be updating the owner of a work item. This automation further improves process efficiency by maintaining the link between the debug session and any related artifacts.

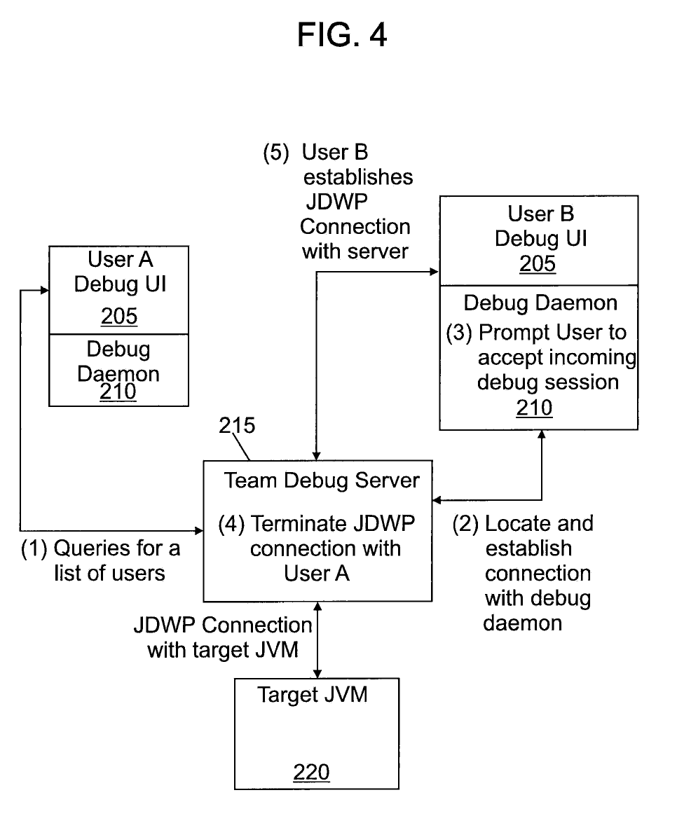

FIG. 4 illustrates a block diagram 400 of one example of the transfer of a debug session from one user to another user in a team environment in accordance with exemplary embodiments. It is appreciated that if the debug session transfer occurs to a team or occurs to a user queue the sequence of events is similar. In exemplary embodiments, the difference between the transfers of the debug session to a team or to a user queue is that there is no accept session prompting when the debug session is queued, and the session is held in suspension until the target user actively assumes control.

In exemplary embodiments, when User A decides to transfer the debug session to User B, the debug UI 205 from User A queries for a list of users from the team debug server 215. User A is then prompted to select a user to whom to transfer the debug session. In this example, User A decides to transfer the debug session to User B. User A's debug UI 205 then requests the team debug server 215 to transfer the debug session to User B. Upon the transfer request, the team debug server 215 locates the host and daemon information for User B and establishes a socket connection with the debug daemon 210 from User B. The debug daemon 215 from User B then receives the socket connection, and prompts Users B to determine if the incoming debug session is to be accepted. User B sends reply back to the team debug server 215, indicating whether or not the debug session is accepted. If User B has accepted the debug session, the team debug server 215 terminates the existing debug connection with the debug UI 205 from User A. Through the daemon connection with User B, the team debug server 215 sends debug connection information to User B, allowing the debug UI 205 to establish a debug connection with the team debug server 215. Once a debug connection is established with User B, the socket connection with its daemon is disconnected. During this process, the debug connection between the team debug server 215 and the target JVM 220 is untouched, thereby maintaining the states of the application being debugged during the transfer.

The capabilities of the present invention can be implemented in software, firmware, hardware or some combination thereof

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. In a computer system having a display, a method for transferring a debug session, the method comprising:
launching the debug session;
logging onto a debug server;
sending a message to establish a connection between the debug server and a target machine;
establishing the debug session with the debug server; and
transferring the debug session to the target machine.

2. The method as claimed in claim 1 wherein launching the debug session comprises:
launching a debug user interface on the display; and
launching a debug daemon configured to open a port and listen for the debug session on the port.

3. The method as claimed in claim 1 further comprising registering the debug daemon's host and port information on the debug server.

4. The method as claimed in claim 1 wherein the debug server maintains a list of users associated with the debug session and information associated with the debug daemon

5. The method as claimed in claim 1 wherein transferring the debug session comprises:
determining the target machine for the transfer of the debug session;
prompting the target machine to accept the debug session; and
disconnecting from the debug sever.

6. In a debug server, a method for transferring a debug session, the method comprising:
receiving a message that a first machine is to transfer the debug session;
establishing a connection with a target machine to receive the debug session;
receiving a message from the target machine that the debug session is accepted;
terminating a connection with the first machine; and
sending debug session connection information to the target machine.

7. The method as claimed in claim 6, further comprising:
sending a message to the first machine to select a target machine to receive the debug session; and
receiving a message from the first machine to transfer the debug session to the target machine.

8. The method as claimed in claim 6 wherein establishing a connection with the target machine, comprises:
locating information related to a target debug daemon; and
establishing a connection with the target debug daemon.

9. The method as claimed in claim 8, further comprising disconnecting the connection with the target debug daemon once the debug session connection information has been sent to the target machine

10. The method as claimed in claim 6 further comprising updating the target machine with a current state of the debug session.

11. The method as claimed in claim 10 further comprising transferring related work artifacts associated with the debug session.

12. A computer program product for transferring a debug session, the computer program product including instructions for causing a computer to implement a method, the method comprising:
receiving a message that a first machine is to transfer the debug session;
establishing a connection with a target machine to receive the debug session;
receiving a message from the target machine that the debug session is accepted;
terminating a connection with the first machine; and
sending debug session connection information to the target machine.

13. The computer program product as claimed in claim 12, wherein the method further comprises:
sending a message to the first machine to select a target machine to receive the debug session; and
receiving a message from the first machine to transfer the debug session to the target machine.

14. The computer program product as claimed in claim 12 wherein establishing a connection with the target machine, comprises:
locating information related to a target debug daemon; and
establishing a connection with the target debug daemon.

15. The computer program product as claimed in claim 14, wherein the method further comprises disconnecting the connection with the target debug daemon once the debug session connection information has been sent to the target machine.

16. The computer program product as claimed in claim 12, wherein the method further comprises updating the target machine with a current state of the debug session.

17. The computer program product as claimed in claim 16, wherein the method further comprises transferring related work artifacts associated with the debug session.

18. A system for transferring a debug session from a first machine to a target machine, the system comprising:
a debug server configured for:
receiving a message that the first machine is to transfer the debug session;
sending a message to the first machine to select a target machine to receive the debug session;
receiving a message from the first machine to transfer the debug session to the target machine;
locating information related to a target debug daemon;
establishing a connection with the target debug daemon;
receiving a message from the target machine that the debug session is accepted;
terminating a connection with the first machine;
sending debug session connection information to the target machine; and
disconnecting the connection with the target debug daemon.

19. The system as claimed in claim 18, wherein the debug server is further configured for:
updating the target machine with a current state of the debug session; and
transferring related work artifacts associated with the debug session.

20. The system as claimed in claim 18 wherein the debug server is further configured for parking the debug session until the debug server transfers the debug session.
